(19) United States
(12) Patent Application Publication
(10) Pub. No.: US 2012/0191938 A1
(43) Pub. Date: Jul. 26, 2012

(54) INFORMATION PROCESSING APPARATUS AND WRITE CONTROL METHOD

(76) Inventor: Katsuki Uwatoko, Tachikawa-shi (JP)

(21) Appl. No.: 13/192,236

(22) Filed: Jul. 27, 2011

(30) Foreign Application Priority Data
Jan. 26, 2011 (JP) 2011-014607

(51) Int. Cl. G06F 12/00

(52) U.S. Cl. 711/170; 711/E12.001

(57) ABSTRACT

According to one exemplary embodiment, an information processing apparatus includes: a first memory having plural management areas managed in units of a first memory capacity; a second memory to which data is written in units of a second memory capacity larger than the first memory capacity; a selector which selects one first management area of the plural management areas; and a writing module which writes data of a number, corresponding to the second memory capacity, of management areas to the second memory, the data including data of the first management area and data of different management areas from the first management area. If after data of the first management area and the different management areas are written to the second memory the selector selects one second management area of the different management areas, the writing module refrains from writing data of the second management area to the second memory.

### CROSS REFERENCE TO RELATED APPLICATION(S)

The application is based upon and claims the benefit of priority from Japanese Patent Application No. 2011-014607 filed on Jan. 26, 2011; the entire content of which are incorporated herein by reference.

### FIELD

Exemplary embodiments described herein relate generally to an information processing apparatus and a write control method.

### BACKGROUND

A technique is known which secures a necessary capacity of a work memory by swapping data out of the work memory to storage such as an HDD or a flash device.

### BRIEF DESCRIPTION OF THE DRAWINGS

Exemplary embodiments of the present invention will be described in detail based on the following figures, wherein:

FIG. 1 shows an example configuration of an information processing apparatus according to an exemplary embodiment;

FIG. 2 shows an example structure of an address management table which is used by the information processing apparatus;

FIG. 3 shows example initial data storage states of the information processing apparatus;

FIG. 4 shows an example operation performed by the information processing apparatus;

FIG. 5 shows another example operation performed by the information processing apparatus;

FIG. 6 shows still another example operation performed by the information processing apparatus;

FIG. 7 shows a further example operation performed by the information processing apparatus; and

FIG. 8 is a flowchart of a process which is executed by the information processing apparatus.

### DETAILED DESCRIPTION OF THE EXEMPLARY EMBODIMENTS

In general, according to one exemplary embodiment, an information processing apparatus is provided with: a first memory having a plurality of management areas which are managed by an operating system in units of a first memory capacity; a second memory to which data is written in units of a second memory capacity that is larger than the first memory capacity; a selector configured to select one first management area of the plurality of management areas of the first memory; and a writing module configured to write data of a number, corresponding to the second memory capacity, of management areas to the second memory, the data including data of the selected first management area and data of different management areas from the first management area, wherein if after the writing module writes data of the first management area and data of the different management areas to the second memory the selector selects one second management area of the different management areas, the writing module is configured to refrain from writing data of the selected second management area to the second memory.

An exemplary embodiment will be hereinafter described with reference to the drawings.

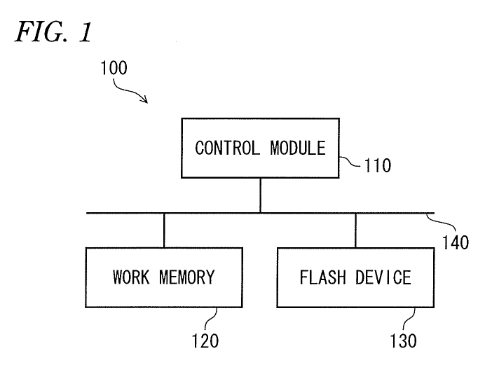

FIG. 1 shows an example system configuration of an information processing apparatus according to the exemplary embodiment. The information processing apparatus 100 according to the exemplary embodiment is used in personal computers, tuners, digital TV receivers, etc. The information processing apparatus 100 is provided with a control module 110 which is a CPU or the like, a work memory 120 which is a volatile memory such as a RAM, a flash device 130 which is a NAND or NOR flash memory or the like, and other devices. The control module 110, the work memory 120, and the flash device 130 are connected to each other by a bus 140.

The work memory 120 has a physical memory space which consist of plural physical pages (plural physical memory areas) and each physical page corresponds to plural respective physical addresses. That is, each physical page can be managed by using each physical address.

The control module 110 cooperates with an OS to control data writing and reading to and from the work memory 120 using a virtual memory space 150 (not shown in FIG. 1). The virtual memory space 150 consists of plural pages (plural virtual memory areas) and each page corresponds to plural respective virtual addresses. That is, each page can be managed by using each virtual address.

For example, the control module 110 generates an address management table 160 (not shown in FIG. 1) for management of a corresponding relationship between plural virtual addresses and plural physical addresses and controls access to data stored at each physical address using a corresponding virtual address according to the address management table 160. The control module 110 controls data access to the work memory 120 in units of a processing unit (page) that is suitable for the OS.

Furthermore, the control module 110 has a function of swapping data out of the work memory 120 to the flash device 130 when, for example, the amount of data stored in the work memory 120 has become larger than or equal to a prescribed threshold value in performing any of various pieces of processing. That is, when the memory capacity of the work memory 120 has become insufficient, the control module 110 writes data that is small in the number of times of access, data whose latest access time is old, or like into a swap file of the flash device 130 from the work memory 120.

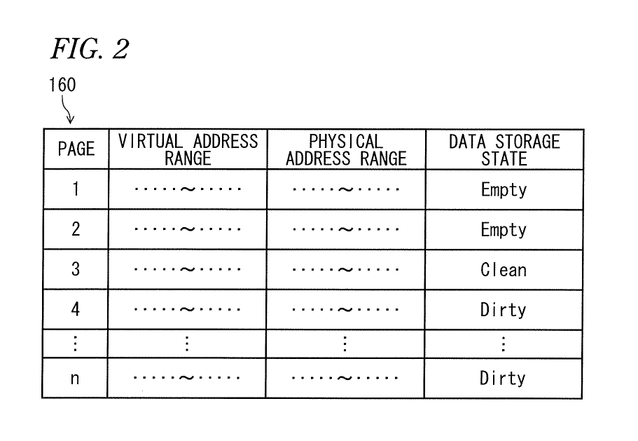

FIG. 2 shows an example structure of the address management table 160 which is generated by the control module 110. In the address management table 160, a virtual address range, a physical address range, and a data storage state are correlated with each page. That is, the memory area of the work memory 120 is managed on a page-by-page basis (page: management area) by the control module 110, and a data storage state is correlated with each page.

The data storage state indicates, for example, whether or not the data in the physical address range that is correlated with the corresponding page has been swapped out to the flash device 130 and whether or not the memory in the physical address range that is correlated with the corresponding page has been freed. For example, “Empty” means that the memory in the physical address range that is correlated with the corresponding page has been freed, “Clean” means that the data in the physical address range that is correlated with the corresponding page has been swapped out and stored in the flash device 130, and “Dirty” means that the data in the physical address range that is correlated with the corresponding page has not been swapped out.

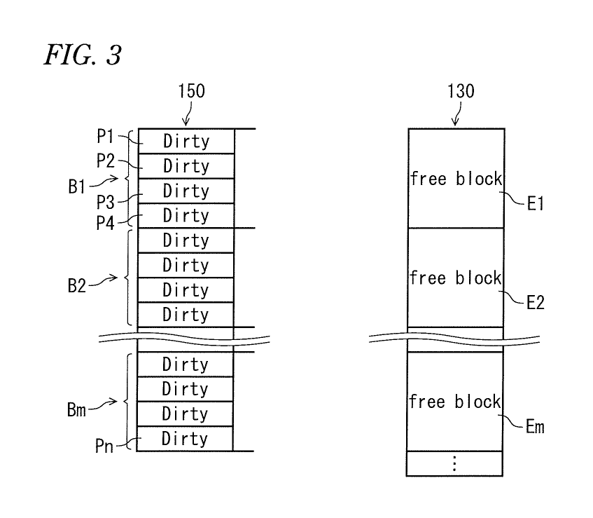

Next, example swap-out-related operations which are performed by the control module 110 will be described with reference to FIGS. 3 to 7.

FIG. 3 shows example data storage states of the virtual memory space 150 and the flash device 130 in a case that the work memory 120 and the flash device 130 are in initial states. The control module 110 manages the virtual memory space 150 in units of a processing unit (memory capacity) of 4 Kbytes, for example, according to the OS and controls data access to the work memory 120 which is address-correlated with the virtual memory space 150. The virtual memory space 150 is blocked into pages P1 to Pn, for example, and each page has a data storage state “Dirty.” That is, data corresponding to each page has not been written to the flash device 130.

Then data is swapped out from the work memory 120 to the flash device 130, the control module 110 performs write processing in units of a processing unit that is a prescribed number of pages. Respective processing units each of which is a prescribed number of pages are called swap blocks B1 to Bm. In the example of FIG. 3, each of the swap blocks B1 to Bm also has a data storage state “Dirty.” The data storage state “Dirty” of a swap block means that the data of at least one of the pages of the swap block has not been swapped out. The data storage state “Clean” of a swap block means that the data of every page of the swap block has been swapped out and written to the flash device 130.

On the other hand, erase blocks E1 to Em which constitute the memory area of the flash device 130 are free blocks from which data have been erased (i.e., no data is stored there) and hence new data can be written there. The erase block is a block as a processing unit (management unit) of rewriting (or erasing) data stored in the flash device 130, and the memory capacity of each erase block is set at 16 or 128 Kbytes, for example. That is, data may be rewritten to the flash device 130 in units of a larger processing unit (erase block) than when the control module 110 accesses the work memory 120 (processing unit: page).

Therefore, the control module 110 swaps data out of the work memory 120 to the flash device 130 in units of plural pages (a swap block) of the virtual memory space 150 that are equal, in capacity, to the rewrite processing unit of the flash device 130.

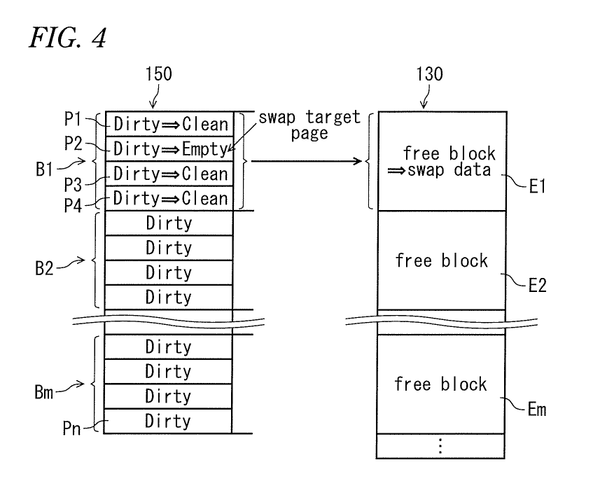

FIG. 4 shows an example operation which is performed by the control module 110 and in which page P2 is designated as a swap target page. The control module 110 writes the data of pages P1 to P4 which belong to the same swap block B1 as the swap target page P2 to area E1 of the flash device 130. Then, the control module 110 frees the memory area corresponding to the swap target page P2 and changes the data storage state of page P2 to “Empty.” When a memory area is freed, it suffices that the control module 110 establishes a state that the OS can recognize that new data can be written to the memory area. The control module 110 may either delete the data from the memory area to be freed or keep the data stored there.

The data storage states of the other pages P1, P3, and P4 which have been subjected to the swap-out together with page P2 are changed to “Clean” which means that the data has been swapped out. The data storage state of the swap block B1 is also changed from “Dirty” to “Clean.” The data of the swap block B1 is written to the erase block E1 of the flash device 130.

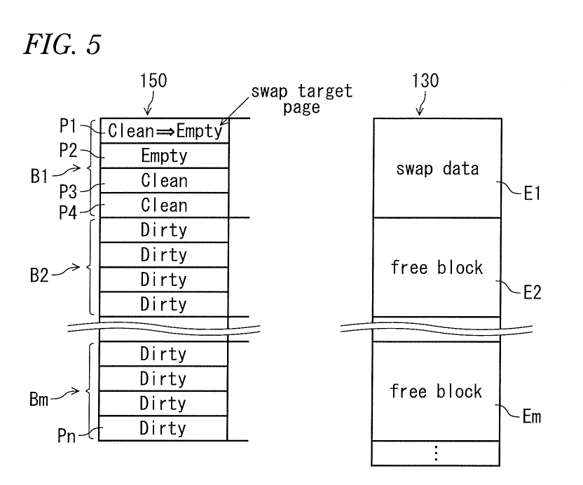

FIG. 5 shows an example operation which is performed by the control module 110 after the completion of the swap-out of FIG. 4 and in which page P1 is designated as a swap target page. In this case, the data of page P1 has already been swapped out. Therefore, the control module 110 does not swap out the data of page P1 again, and frees the memory area corresponding to page P1 and changes the corresponding data storage state in the address management table 160 from “Clean” to “Empty.” Since the data of the swap block B1 has already been swapped out, the control module 110 does not change the data storage state of the swap block B1 from “Clean.”

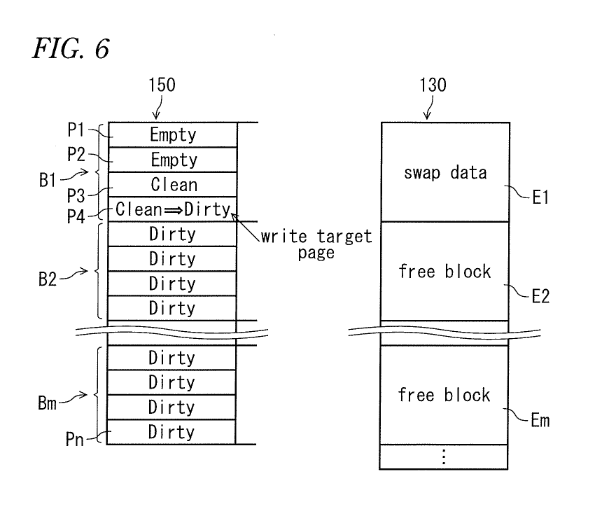

FIG. 6 shows an example operation which is performed by the control module 110 after the completion of the freeing of page P2 by the operation of FIG. 5 and in which the memory area of page P4 is designated as a write target area. After writing data to page P4, the control module 110 changes the data storage state of page P4 to “Dirty” which means that the data has not been swapped out. Whereas in this example page P4 is a write target page, if one of pages P1 to P3 is a write target page, the control module 110 writes data to the write target page and changes the data storage state of the write target page to “Dirty.”

Then, the control module 110 changes the data storage state of the swap block B1 from “Clean” to “Dirty.” If the data storage state of the write target page is “Dirty,” the control module 110 writes data to the memory area that is correlated with the write target page and does not change its data storage state from “Dirty.”

The example operation of FIG. 6 is an operation that includes writing. If page P4 having a data storage state “Clean” is designated as a read target page in the state that the operation of FIG. 5 has been completed, the control module 110 reads the data from the memory area corresponding to page P4 and does not change the data storage state of page P4 from “Clean.” On the other hand, if read processing should be performed on page P1 or P2 having a data storage state “Empty” (its memory is freed) in the state that the operation of FIG. 5 has been completed, the control module 110 reads the data that had been stored in the read target page before its memory was freed from the flash device 130 to which the data was swapped out, and writes the data to the read target page, as a general processing of swap-in according to OS. Then, the control module 110 changes the data storage state of the read target page from “Empty” to “Clean.”

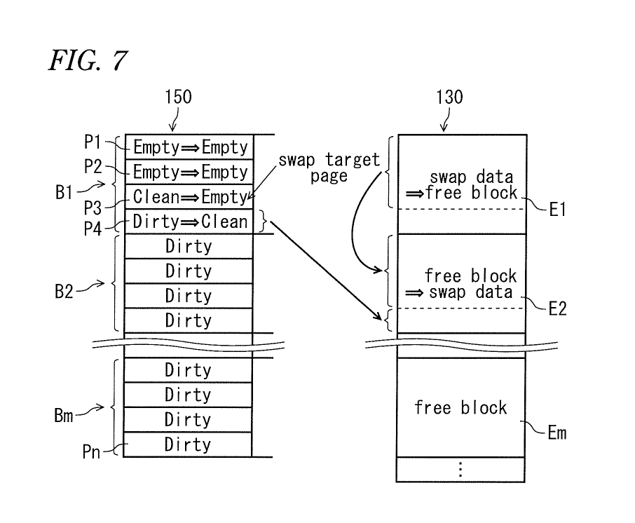

FIG. 7 shows an example operation which is performed by the control module 110 after the completion of the writing to page P4 by the operation of FIG. 6 and in which page P3 is designated as a swap-out target page. Since the data corresponding to page P4 which belongs to the same swap block B1 as page P3 has not been swapped out to the flash device 130, the control module 110 swaps the data in the memory area corresponding to page P4 to the flash device 130.

The data corresponding to pages P1 to P3 having a data storage state “Empty” or “Clean” are stored in the memory areas of the flash device 130. Therefore, the control module 110 writes, to the flash device 130, the data corresponding to pages P1 to P3 that are stored in the flash device 130 and the data corresponding to page P4 that is stored in the work memory 120. In this case, the control module 110 writes these data to an erase block that is different from the erase block E1 where the data corresponding to pages P1 to P3 are stored.

Then, the control module 110 frees the memory area corresponding to the swap-out target page P3 and changes its data storage state from “Clean” to “Empty.” And the control module 110 changes the data storage state of page P4 which belongs to the swapped-out swap block B1 from “Dirty” to “Clean.”

Furthermore, the control module 110 changes the data storage state of swap block B1 from “Dirty” to “Clean.”

In the example operation of FIG. 7, the control module 110 may read the data corresponding to pages P1 to P4 from the work memory 120 and write those data to the erase block E2 of the flash device 130.

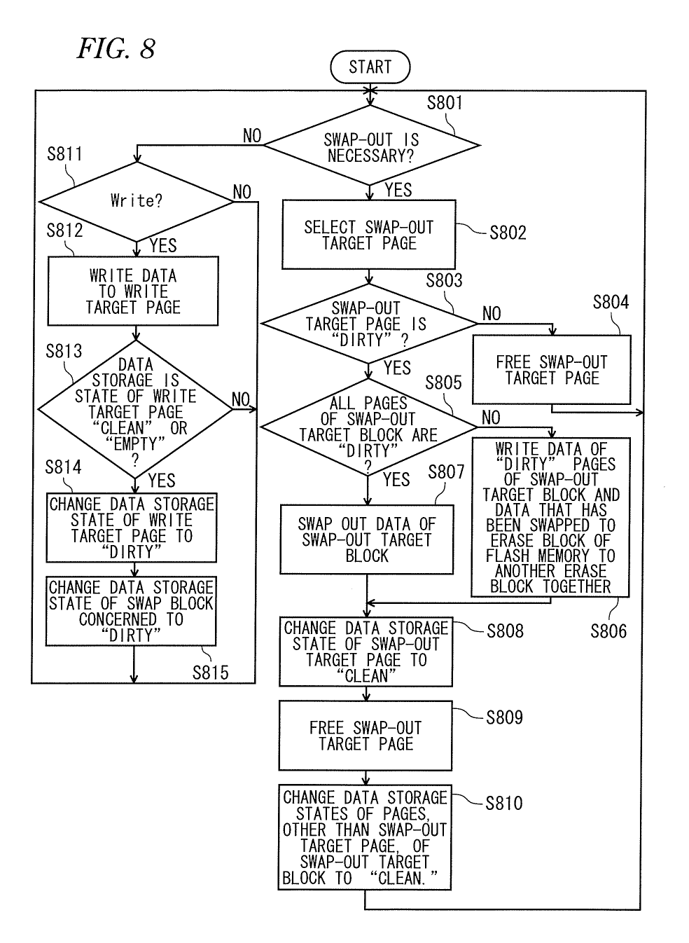

FIG. 8 is a flowchart of a swap-out-related process which is executed by the control module 110. First, if the number of writable memory areas of the work memory 120 has become smaller than or equal to a prescribed number (S801: Yes), at step S802 the control module 110 selects a swap-out target page. For example, the control module 110 may select a swap-out target page based on the number of times of access to the respective pages.

That is, the control module 110 may select, as a swap-out target page, a page that is smaller in the number of times of access than the other pages, a page having the oldest last access time, or a like page. Alternatively, at step S802, the control module 110 may preferentially select, as a swap-out target page, a page that belongs to a swap block having a data storage state “Clean.”

At step S803, the control module 110 determines, by referring to the address management table 160, whether or not the data storage state of the selected swap-out target page is “Dirty” which means that the data of the memory area, corresponding to the selected page, of the work memory 120 has not been written to the flash device 130. If the data corresponding to the selected page is stored in the work memory 130, that is, the data storage state of the swap-out target page is “Clean” or “Empty” (S803: No), at step S804 the control module 110 frees the memory area corresponding to the swap-out target page. If the data storage state of the swap-out target page is “Empty” which means that the page is already freed, the control module 110 may refrain from freeing the swap-out target page at step S804.

On the other hand, if the data storage state of the swap-out target page is “Dirty” (S803: Yes), the control module 110 at step S805 whether or not the data storage states of all the pages of the swap block to which the swap-out target page belongs are “Dirty.” If the data storage state of at least one of the pages of the swap block is “Clean” or “Empty”, that is, the data corresponding to at least one of the pages of the swap block is stored in the flash device 130 (S805: No), at step S806 the control module 110 performs an operation as described above with reference to FIG. 7.

That is, the control module 110 writes, to the flash device 130, the data corresponding to the non-swapped-out pages that belong to the same swap block as the swap-out target page and the data that is (are) stored in the flash device 130 and corresponds to the page(s), other than the non-swapped-out pages, of the swap block. The control module 110 writes those data to an erase block that is different from the erase block where the data corresponding to the page(s) other than the non-swapped-out pages has been stored among the erase blocks of the flash device 130.

On the other hand, if the data storage states of all the pages of the swap block to which the swap-out target page belongs are “Dirty” (S805: Yes), at step S807 the control module 110 swaps the data of the swap block out of the work memory 120 to the flash device 130. At step S808, the control module 110 changes the data storage state of the swap block to “Clean.”

At step S809, the control module 110 frees the memory area corresponding to the swap-out target page and changes its data storage state to “Empty.” At step S810, the control module 110 changes the data storage states of the pages, other than the swap-out target page of the swap block to “Clean.” Then, the process returns to step S801.

A description will now be made of a case that data need not be swapped out of the work memory 120 (S801: No). If the control module 110 is to write data to a memory area of the work memory 120 (S811: Yes), at step S812 the control module 110 select a write target page and writes the data to the memory area corresponding to the selected page. If the data storage state of the write target page was “Clean” or “Empty” before the writing (S813: Yes), the control module 110 generates exceptional processing (interrupt processing) and detects the write processing. Then, at step S814, the control module 110 changes the data storage state of the write target page to “Dirty”. At step S815, the control module 110 changes the data storage state of the swap block concerned to “Dirty.” Then, the process returns to step S801.

On the other hand, if the data storage state of the write target page was “Dirty” (S813: No), the control module 110 does not generate exceptional processing. Then, the process returns to step S801.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first memory having a plurality of management areas which are managed by an operating system in units of a first memory capacity;
a second memory to which data is written in units of a second memory capacity that is larger than the first memory capacity;
a selector configured to select one first management area of the plurality of management areas of the first memory; and
a writing module configured to write data of a number, corresponding to the second memory capacity, of management areas to the second memory, the data including data of the selected first management area and data of different management areas from the first management area,
wherein if after the writing module writes data of the first management area and data of the different management areas to the second memory the selector selects one second management area of the different management areas, the writing module is configured to refrain from writing data of the selected second management area to the second memory.

2. The apparatus of claim 1, wherein the selector is configured to preferentially select a management area whose data is written to the second memory by the writing module among the plurality of management areas.

3. The apparatus of claim 1,
wherein the first memory is managed by the operating system in units of a management block which includes a number, corresponding to the second memory capacity, of management areas,
wherein data is written to the second memory in units of a write block having the second memory capacity; and
wherein if a management block including the selected first management area includes a management area whose data is written to the second memory and a management area whose data is not written to the second memory, the writing module is configured to write the written data and the unwritten data to a write block other than a write block in which the written data is stored.

4. The apparatus of claim 3, wherein the writing module is configured to write the written data that is written in the second memory and the unwritten data to the write block other than the write block in which the written data is stored.

5. The apparatus of claim 3, wherein the writing module is configured to write the written data that is stored in the first memory and the unwritten data to the write block other than the write block in which the written data is stored.

6. A write control method of an apparatus which is provided with: a first memory having a plurality of management areas which are managed by an operating system in units of a first memory capacity; and a second memory to which data is written in units of a second memory capacity that is larger than the first memory capacity, comprising:
selecting one first management area of the plurality of management areas of the first memory;
writing data of a number, corresponding to the second memory capacity, of management areas to the second memory, the data including data of the selected first management area and data of different management areas from the first management area,
if after the writing step writes data of the first management area and data of the different management areas to the second memory the selecting step selects one second management area of the different management areas, refraining from writing data of the selected second management area to the second memory.
